(19) United States
(12) Patent Application Publication
(10) Pub. No.: US 2026/0352903 A1
(43) Pub. Date: Nov. 5, 2026

(54) METHOD, APPARATUS, DEVICE AND STORAGE MEDIUM FOR ADAPTIVE BITRATE STREAMING

(71) Applicant: Bytedance Technology Ltd., Grand Cayman (KY)

(72) Inventors: Jinghao Yuan, Beijing (CN); Lei Xiao, Beijing (CN)

(21) Appl. No.: 19/713,305

(22) Filed: Jun. 18, 2026

(51) Int. Cl. H04N 21/2365; H04N 21/647

(52) U.S. Cl. CPC H04N 21/23655; H04N 21/647

(57) ABSTRACT

A method, an electronic device, and a storage medium for adaptive bitrate streaming are provided. In a solution, bandwidth estimation information is received from a server via a transport layer connection. The bandwidth estimation information carries at least one network quality metric. A capability of the bandwidth estimation information has been negotiated during a handshake phase of the transport layer connection. A media segment is presented based on the at least one network quality metric.

### FIELD

Examples of the present disclosure generally relate to the field of communication technology, and in particular, to a method, an electronic device, and a storage medium for adaptive bitrate streaming.

### BACKGROUND

Adaptive bitrate streaming (ABR) is a technique in which a client dynamically selects a video bitrate based on network conditions and device performance, balancing playback smoothness and video quality. In a typical ABR system, the client may estimate available bandwidth by measuring download speed during media segment retrieval and use the estimated bandwidth to select a bitrate for subsequent segments.

### SUMMARY

In a first aspect, a method for adaptive bitrate streaming is provided. The method includes: receiving, via a transport layer connection, bandwidth estimation information from a server, the bandwidth estimation information carrying at least one network quality metric, a capability of the bandwidth estimation information having been negotiated during a handshake phase of the transport layer connection; and presenting a media segment based on the at least one network quality metric.

In a second aspect, an electronic device is provided. The electronic device comprises at least one processor; and at least one memory coupled to the at least one processor and having instructions executable by the at least one processor stored thereon, the instructions, when executed by the at least one processor, causing the electronic device to perform operations comprising: receive, via a transport layer connection, bandwidth estimation information from a server, the bandwidth estimation information carrying at least one network quality metric, a capability of the bandwidth estimation information having been negotiated during a handshake phase of the transport layer connection; and present a media segment based on the at least one network quality metric.

In a third aspect, a non-transitory computer-readable storage medium storing instructions is provided. The instructions, when executed by one or more processors, cause the one or more processors to perform operations comprising: receiving, via a transport layer connection, bandwidth estimation information from a server, the bandwidth estimation information carrying at least one network quality metric, a capability of the bandwidth estimation information having been negotiated during a handshake phase of the transport layer connection; and presenting a media segment based on the at least one network quality metric.

It would be appreciated that content described in this Summary section is neither intended to identify key or essential features of the examples herein, nor is it intended to limit the scope. Other features herein will be readily envisaged through the following description.

### BRIEF DESCRIPTION OF THE DRAWINGS

The above and other features, advantages, and aspects of the examples herein will become more apparent in combination with the drawings and with reference to the following detailed description. In the drawings, the same or similar reference symbols refer to the same or similar elements, where:

FIG. 1 illustrates a schematic diagram of an example environment in which the examples may be implemented;

FIG. 2 illustrates a block diagram of a conventional ABR architecture;

FIG. 3 illustrates a block diagram of an example ABR architecture in accordance with some examples;

FIG. 4 illustrates a schematic diagram of a bandwidth estimation frame structure in accordance with some examples;

FIG. 5 illustrates a flowchart of a process for adaptive bitrate streaming in accordance with some examples;

FIG. 6 illustrates a schematic structural block diagram of an apparatus for adaptive bitrate streaming in accordance with some examples; and

FIG. 7 illustrates a block diagram of an electronic device capable of implementing various examples.

### DETAILED DESCRIPTION

The examples herein will be described in more detail below with reference to the drawings. Although some examples herein are shown in the drawings, it would be appreciated that the examples may be implemented in various forms and should not be construed as being limited to the examples set forth herein. On the contrary, these examples are provided for a more thorough and complete understanding of the examples. It would be appreciated that the drawings and examples herein are only for illustrative purposes and are not intended to limit the protection scope.

It should be noted that the titles of any sections/subsections provided herein are not restrictive. Various examples are described throughout this text, and any type of examples may be included under any section/subsection. Furthermore, the examples described in any section/subsection may be combined with any other examples described in the same section/subsection and/or different sections/subsections in any manner.

In the description of the examples herein, the term “include/comprise” and similar terms thereto should be understood as open-ended inclusions, that is, “include/comprise but not limited to”. The term “based on” should be understood as “at least partially based on”. The term “one example” or “the example” should be understood as “at least one example”. The term “some examples” should be understood as “at least some examples”. Other explicit and implicit definitions may also be included below. The terms “first”, “second”, etc. may refer to different or same objects. Other explicit and implicit definitions may also be included below.

The examples herein may involve user's data, acquisition and/or use of data, etc. These aspects all comply with corresponding laws, regulations, and related provisions. In the examples herein, all data collection, acquisition, processing, machining, forwarding, use, etc. are performed on the premise that users are aware and confirm. Accordingly, when implementing the examples herein, users should be informed of the type, range of use, use scenarios, etc., of possible data or information involved and obtain users' authorization through appropriate means according to relevant laws and regulations. The specific means of informing and/or authorizing may vary according to actual situations and application scenarios, and the scope is not limited in this regard.

If the solutions in this specification and examples involve personal information processing, the processing will be performed on the premise that there is a legal basis (for example, the consent of the personal information subject is obtained, or it is necessary to perform a contract, etc.), and the processing will only be performed within the scope of regulations or agreements. If a user refuses to process personal information other than the necessary information required for the basic functions, it will not affect the user's use of the basic functions.

As used herein, the term “adaptive bitrate streaming” (ABR) refers to a technique in which a client dynamically selects a video bitrate based on network conditions and device performance, balancing playback smoothness and video quality. As used herein, the term “bandwidth estimation frame” (BWE Frame) refers to a data structure transmitted via a transport layer connection that carries network quality metrics evaluated by a server, the bandwidth estimation frame being used to convey bandwidth estimation information from the server to a client for adaptive bitrate decision-making. As used herein, the term “transport layer connection” refers to a connection established at the transport layer of a network protocol stack, such as a Quick UDP Internet Connections (QUIC) connection, through which data may be exchanged between a client and a server. As used herein, the term “network quality metric” refers to a parameter that reflects a network condition, including but not limited to a bandwidth value, a round-trip time (RTT) value, a loss rate value, or a jitter value. As used herein, the term “Type-Length-Value” (TLV) structure refers to a data encoding format comprising a type field identifying a category of information, a length field specifying a size of a value field, and a value field containing actual data, the TLV structure being extensible for addition of further metric types. As used herein, the term “media segment” refers to a portion of media content, such as a video segment encoded at a particular bitrate, that may be requested and presented by a client during adaptive bitrate streaming. As used herein, the term “bitrate level” refers to one of a plurality of encoding quality levels at which media content is made available, each bitrate level corresponding to a bandwidth requirement threshold.

FIG. 1 illustrates a schematic diagram of an example environment 100 in which the examples may be implemented. As shown in FIG. 1, the example environment 100 may include a client 110 and a server 130. In the example environment 100, the client 110 may run an application 120 that supports adaptive bitrate streaming. The application 120 may be any appropriate type of application for adaptive bitrate streaming, including but not limited to: a video streaming application, a live streaming application, a media player application, or other appropriate applications. A user 140 may interact with the application 120 via the client 110 and/or attached devices thereof.

In the environment 100 of FIG. 1, if the application 120 is in an active state, the client 110 may present, through the application 120, an interface for supporting adaptive bitrate streaming and media playback. In some examples, the client 110 communicates with the server 130 to enable provision of services for the application 120.

The client 110 may be any type of mobile terminal, fixed terminal, or portable terminal, including a mobile phone, a desktop computer, a laptop computer, a notebook computer, a netbook computer, a tablet computer, a media computer, a multimedia tablet, a personal digital assistant (PDA), a personal communication system (PCS) device, a personal navigation device, an audio/video player, a digital camera/camcorder, a positioning device, a television receiver, a radio broadcast receiver, an electronic book device, a gaming device, a virtual reality (VR) device, an augmented reality (AR) device, or any combination of the foregoing, including accessories and peripherals of these devices or any combination thereof. In some examples, the client 110 may also support any type of user-facing interface (such as a “wearable” circuit, etc.).

The server 130 may be a standalone physical server, a server cluster composed of multiple physical servers, a distributed system, or a cloud server providing cloud services, cloud databases, cloud computing, cloud functions, cloud storage, network services, cloud communications, middleware services, domain name services, security services, content delivery networks, and big data and artificial intelligence platforms, among other basic cloud computing services. The server 130 may include, for example, computing systems/servers such as mainframes, edge computing nodes, computing devices in a cloud environment, and the like. The server 130 may provide backend services for the application 120 supporting adaptive bitrate streaming on the client 110. In some examples, the server 130 may evaluate network conditions and provide bandwidth estimation information to the client 110 for use in adaptive bitrate decision-making.

A communication connection may be established between the server 130 and the client 110. The communication connection may be established through a wired manner or a wireless manner. The communication connection may include, but is not limited to, a Bluetooth connection, a mobile network connection, a Wireless Fidelity (WiFi) connection, a transport layer connection and the like, and is not limited in this regard. In some examples, the server 130 and the client 110 may implement signaling interaction through the communication connection therebetween. In some examples, the communication connection may be a transport layer connection, such as a Quick UDP Internet Connections (QUIC) connection, through which bandwidth estimation frames and media data may be communicated between the server 130 and the client 110.

It should be understood that the structure and functions of the various elements in the environment 100 are described for illustrative purposes, and do not imply any limitation on the scope of the solutions. The following will continue to describe examples with reference to the accompanying drawings.

As discussed above, ABR is a technique widely applied in video live streaming and video-on-demand scenarios. The working principle of ABR involves a client dynamically selecting an appropriate video bitrate based on real-time network conditions and device performance, thereby balancing playback smoothness and video quality in fluctuating network environments.

In an ABR architecture or an ABR system, video content may be encoded at the server side into multiple segments at different bitrates (such as a low bitrate 360P, a medium bitrate 720P, a high bitrate 1080P, etc.) and provided to the client through streaming protocols (such as HTTP Live Streaming (HLS), Dynamic Adaptive Streaming over HTTP (DASH), Quick UDP Internet Connections (QUIC), etc.). During playback, the client may continuously monitor relevant metrics and select the bitrate for the next segment according to a preset decision algorithm, achieving adaptive adjustment where higher bitrates are selected for better video quality when network conditions are good, and lower bitrates are selected to maintain smooth playback when network conditions are poor.

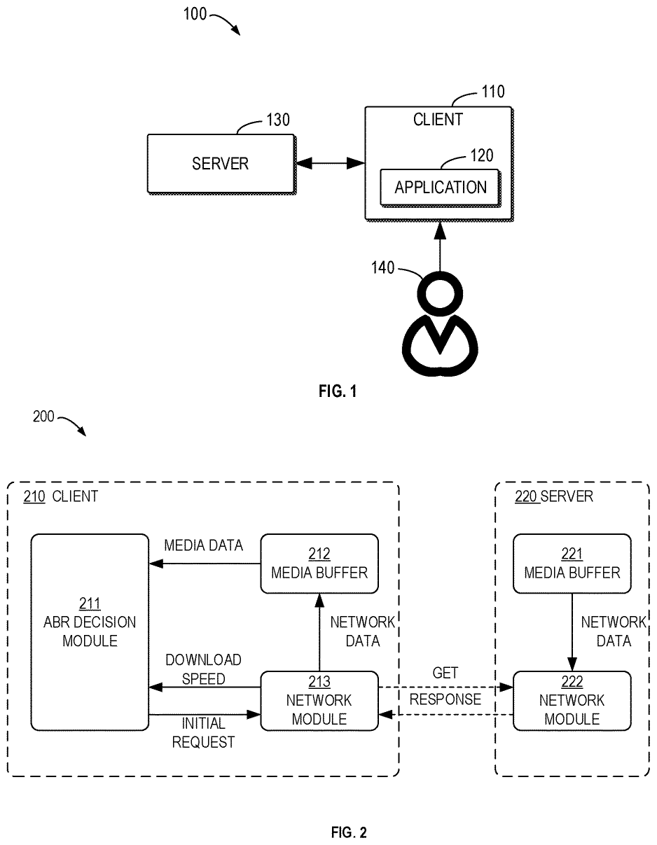

More details related to the ABR architecture will be discussed below with reference to FIG. 2, which illustrates a block diagram of a conventional ABR architecture 200. As shown in FIG. 2, the architecture 200 includes a client 210 and a server 220 that communicate over a network connection. The client 210 may include an ABR decision module 211, a media buffer 212, and a network module 213. The ABR decision module 211 is the core decision-making component residing on the client side. It receives media data from the media buffer 212 and download speed information from the network module 213, and utilizes both inputs to dynamically determine the appropriate bitrate level for subsequent media segment requests. It also generates an initial request that is forwarded to the network module 213 to initiate the streaming session.

The media buffer 212 temporarily stores media content received from the network module 213. It supplies buffered media data to the ABR decision module 211 to reflect current buffer occupancy status, which serves as one of the key inputs for bitrate adaptation decisions. The media buffer 212 also receives network data from the network module 213 reflecting the state of incoming media segments.

The network module 213 serves as the communication interface between the client 210 and the server 220. It transmits a GET request (e.g., an HTTP GET request) to a network module 222 of the server 220 to request media segments, and receives a response (e.g., an HTTP response) therefrom. The network module 213 measures and reports download speed to the ABR decision module 211, delivers network data to the media buffer 212, and processes the initial request issued by the ABR decision module 211.

The server 220 may include a media buffer 221 and a network module 222. The media buffer 221 may store media content and provide network data to the network module 222. The network module 222 may process network data and provide a response to the network module 213 of the client 210 in response to the GET request from the network module 213 of the client 210.

In operations, the ABR decision module 211 may receive media data from the media buffer 212 and download speed feedback from the network module 213, and use these inputs to adaptively select the bitrate of the next requested segment. The network module 213 may issue GET requests to the network module 222 of the server 220, which retrieves segments from the media buffer 221 of the server 220 and returns them via a response. The received data may then be passed as network data from the network module 213 of the client 210 to the media buffer 212 of the client 210, completing the data flow loop for continuous adaptive bitrate streaming.

In the decision logic of an ABR architecture, network bandwidth estimation may be a core parameter that directly determines the accuracy of bitrate selection. In the architecture 200 of FIG. 2, the bandwidth estimation mechanism may be implemented based on download speed measurement at the side of the client 210. When downloading video segments, the client 210 may record data such as the file size of the segment and the actual download time, calculates the real-time available bandwidth through a formula of “bandwidth≈segment size/download time,” and combines this with smoothing processing of historical bandwidth data to obtain a bandwidth estimation result for bitrate decision-making. After obtaining the estimated bandwidth, the ABR decision module 211 may perform the next round of decision-making, requesting content at a bitrate level that matches the network conditions. When the next requested content arrives, a new bandwidth and bitrate decision may be calculated, thereby achieving continuous self-driven operation.

The bandwidth estimation approach is a mainstream solution in ABR systems. However, such client-side bandwidth estimation based on download speed is inherently a post-hoc measurement of completed download processes, which may have difficulty in timely perceiving sudden fluctuations in network conditions, such as instantaneous congestion or rapid bandwidth increases or decreases. Furthermore, the estimation results may be subject to interference from local factors at the client side, such as computing resource availability and cache status, potentially causing delays or deviations in bandwidth estimation, thereby affecting the timeliness and accuracy of ABR decisions. Accordingly, there exists a need for an improved bandwidth strategy mechanism with high reliability and strong responsiveness to network changes.

A solution for a method for adaptive bitrate streaming is proposed. According to the solution, bandwidth estimation information is received from a server via a transport layer connection. The bandwidth estimation information carries at least one network quality metric. A capability of the bandwidth estimation information has been negotiated during a handshake phase of the transport layer connection. A media segment is presented based on the at least one network quality metric.

Through the above solution, the server may evaluate network conditions and proactively provide bandwidth estimation information to the client, enabling the client to leverage server-side network evaluation results for adaptive bitrate decision-making, rather than relying solely on client-side post-hoc measurement of completed downloads. Since the capability of the bandwidth estimation information is negotiated during the handshake phase of the transport layer connection, the client and the server may confirm support for the bandwidth estimation information at the time of connection establishment, thereby enabling reliable transmission of the bandwidth estimation information. This approach may improve the timeliness of perceiving network fluctuations (such as instantaneous congestion or rapid bandwidth changes), reduce delays or deviations in bandwidth estimation, and thereby improve the timeliness and accuracy of adaptive bitrate decisions.

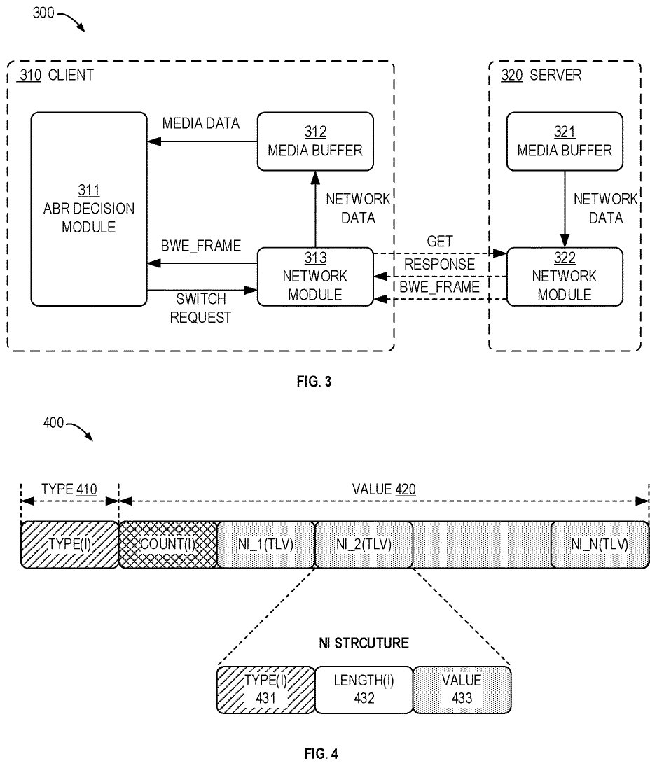

The following further describes various examples in detail with reference to the accompanying drawings. FIG. 3 illustrates a block diagram of an example architecture 300 for adaptive bitrate streaming with server-assisted bandwidth estimation in accordance with some examples. As shown in FIG. 3, the architecture 300 includes a client 310 and a server 320. The client 310 may be an example of the client 110 as discussed with reference to FIG. 1, and the server 320 may be an example of the server 130 as discussed with reference to FIG. 1. The client 310 and the server 320 may communicate with each other to facilitate media streaming and network condition assessment.

In the architecture 300, the client 310 receives bandwidth estimation information from the server 320 via a transport layer connection. The bandwidth estimation information carries at least one network quality metric, and a capability of the bandwidth estimation information has been negotiated during a handshake phase of the transport layer connection. Based on the at least one network quality metric, the client 310 presents a media segment.

Through this approach, the client 310 may obtain network quality information evaluated by the server 320 rather than relying solely on client-side post-hoc measurement of completed downloads, and since the capability of the bandwidth estimation information is negotiated during the handshake phase, the client 310 and the server 320 may begin reliable transmission of bandwidth estimation information immediately upon connection establishment.

To support the above approach, the transport layer connection between the client 310 and the server 320 may be established using a transport protocol that supports low-latency connection establishment and capability negotiation. In some examples, the transport layer connection between the client 310 and the server 320 is a QUIC connection. Through the use of a QUIC connection, the client 310 and the server 320 may leverage the low-latency and multiplexing capabilities of QUIC for efficient transmission of bandwidth estimation information together with media data. Where the transport layer connection is a QUIC connection, the capability of the bandwidth estimation information may be negotiated via an extension field of an initial packet of the QUIC connection. Through this approach, the negotiation between the client 310 and the server 320 may be completed during the initial connection establishment phase, reducing negotiation latency and enabling the client 310 to begin receiving bandwidth estimation frames as soon as the QUIC connection is ready. Furthermore, the bandwidth estimation information may be a bandwidth estimation frame having a predefined frame type identifier.

In some examples, the bandwidth estimation information transmitted from the server 320 to the client 310 may have a structured format to facilitate efficient parsing by the client 310. The bandwidth estimation information may comprise a frame type field and a frame value field, the frame value field comprising a count field and at least one network information field. Through this structured format, the client 310 may efficiently parse the bandwidth estimation information received from the server 320 and extract network quality metrics for ABR decision-making.

Within the frame value field, the count field may indicate a number of network information fields comprised in the frame value field. Through the count field, the client 310 may determine in advance how many network quality metrics are included in the bandwidth estimation information received from the server 320, facilitating accurate parsing of the bandwidth estimation frame and reliable extraction of network conditions for ABR decision-making.

To support flexible and extensible encoding of network quality metrics, each network information field may have a Type-Length-Value (TLV) structure, the TLV structure comprising a type field, a length field, and a value field, and/or being extensible for addition of a further metric type. Through the TLV structure, the server 320 may flexibly encode various types of network quality metrics in the bandwidth estimation information, and the client 310 may parse each network information field according to its type and length, while also supporting future addition of new metric types without breaking compatibility, providing good extensibility for evolving ABR streaming requirements. More details related to the structure of the bandwidth estimation frame may be described in FIG. 4.

The at least one network quality metric carried in the bandwidth estimation information may include various types of network condition indicators. In some examples, the at least one network quality metric carried in the bandwidth estimation information may comprise at least one of: a bandwidth value, a round-trip time value, a loss rate value, or a jitter value. Through these network quality metrics provided by the server 320, the client 310 may obtain comprehensive multi-dimensional network condition information to make informed bitrate selection decisions, enabling more stable and accurate ABR decisions compared to relying on a single bandwidth metric.

Each of these network quality metrics may reflect a particular aspect of the network condition as evaluated by the server 320. In some examples, the at least one network quality metric carried in the bandwidth estimation information may be associated with at least one network condition of the transport layer connection evaluated by the server 320. Through the server-evaluated network conditions, the client 310 may leverage the server 320's network evaluation capabilities, which may have access to more comprehensive and forward-looking network information than the client 310 alone.

During the handshake phase of the transport layer connection, the capability of the bandwidth estimation information may be negotiated between the client 310 and the server 320. Specifically, the client 310 may transmit, to the server 320, indication information of the capability of the bandwidth estimation information. Then the client 310 may receive, from the server 320, confirmation information about the capability of the bandwidth estimation information. Through this bidirectional negotiation process during the handshake phase, the client 310 and the server 320 may confirm mutual support for bandwidth estimation and agree on transmission parameters before bandwidth estimation frames are exchanged.

The indication information transmitted from the client 310 to the server 320 may inform the server 320 of the client 310's capabilities for receiving bandwidth estimation information. In some examples, the indication information of the capability of the bandwidth estimation information comprises at least one of: an indication of bandwidth estimation support, a frame type identifier, or a transmission interval that is requested. Through these indication parameters, the client 310 may specify its preferences and capabilities for receiving bandwidth estimation information to the server 320, allowing the server 320 to tailor the bandwidth estimation frame transmission according to the client 310's capabilities. For example, a value of 0 may indicate that the client 310 does not support bandwidth estimation frames, and a value of 1 may indicate that the client 310 supports bandwidth estimation frames. The frame type identifier may indicate a type of the bandwidth estimation frame. The transmission interval may indicate a time interval at which the server 320 transmits bandwidth estimation frames to the client 310.

By including these parameters in the indication information, the client 310 may specify its preferences and capabilities for receiving bandwidth estimation information, allowing the server 320 to tailor the bandwidth estimation information accordingly.

Table 1 shows an example of negotiation parameters that may be included in the indication information.

TABLE 1

| Parameter Name | Description | Data Length |
|---|---|---|
| BWE_Support | Whether bandwidth | 1 byte |
| | estimation frames are | |
| | supported (0 = not | |
| | supported, 1 = supported) | |
| BWE_Send_Interval | Interval at which | 1 byte |
| | bandwidth estimation | |
| | frames are sent (unit: ms) | |

In response to the indication information, the confirmation information transmitted from the server 320 to the client 310 may indicate the agreed bandwidth estimation parameters. In some examples, the confirmation information about the capability of the bandwidth estimation information comprises at least one of: an indication of acceptance, an identifier of a frame type, or a transmission interval that is confirmed. The bandwidth estimation information may be received by the client 310 from the server 320 according to a transmission interval that is confirmed. Through these confirmation parameters, the server 320 may inform the client 310 of the agreed bandwidth estimation parameters, ensuring that the client 310 knows what to expect when receiving bandwidth estimation frames from the server 320 during the streaming session. For example, a value of 0 may indicate that the server 320 rejects the use of bandwidth estimation frames, and a value of 1 may indicate that the server 320 agrees to use bandwidth estimation frames. The identifier of a frame type may indicate a type identifier assigned to the bandwidth estimation frame. The transmission interval that is confirmed may indicate a time interval at which the server 320 will transmit bandwidth estimation frames to the client 310. After the negotiation is completed, the transport layer connection enters a stable state, and both the client 310 and the server 320 have confirmed the identifier and transmission parameters of the bandwidth estimation frame, preparing for subsequent bandwidth estimation.

By including these parameters in the confirmation information, the server 320 may confirm the parameters of the bandwidth estimation information, ensuring that the client 310 knows what to expect when receiving bandwidth estimation frames.

Table 2 shows an example of confirmation parameters that may be included in the confirmation information.

TABLE 2

| Parameter Name | Description | Data Length |
|---|---|---|
| BWE_Accept | Whether the server agrees | 1 byte |
| | to use bandwidth | |
| | estimation frames (0 = | |
| | disagree, 1 = agree) | |
| BWE_Frame_Type | Dedicated type identifier | 1 byte |
| | for the bandwidth | |
| | estimation frame (e.g., | |
| | predefined as 0x1f) | |
| BWE_Send_Interval | Interval at which | 1 byte |
| | bandwidth estimation | |
| | frames are sent (unit: ms) | |

To avoid interference between bandwidth estimation and media content delivery, the bandwidth estimation information and media data may be transmitted with isolation at the transport layer. In some cases where the bandwidth estimation information includes a bandwidth estimation frame, the bandwidth estimation frame and one or more media data frames carrying the media segment may be transmitted via the transport layer connection with separate flow controls between the client 310 and the server 320. In this way, the bandwidth estimation frame may be transmitted independently of the media data frames carrying video segments, avoiding interference from media business traffic on bandwidth estimation results and enabling the client 310 to obtain more accurate network quality measurements for ABR decision-making.

In some examples, upon receiving data or frames from the server 320, the client may identify and validate the bandwidth estimation information. Specifically, the client 310 may perform identification and validation before using the bandwidth estimation information for ABR decision-making. In some examples, the client 310 may further identify, from a plurality of received frames, the bandwidth estimation information based on a predefined frame type identifier. Then, the client 310 may validate at least one field of the bandwidth estimation information. Through this identification and validation process, the client 310 may filter bandwidth estimation frames from other types of frames received from the server 320 and verify their integrity, ensuring that only valid bandwidth estimation information is used for bitrate selection.

After the bandwidth estimation information has been validated, the client 310 may use the network quality metrics to select a bitrate for presenting the media segment. In some examples, the client 310 may compare a bandwidth value in the bandwidth estimation information from the at least one network quality metric against a plurality of bitrate thresholds associated with different bitrate levels. Based on the comparison, the client 310 may select a bitrate for presenting the media segment. Through this threshold comparison approach, the client 310 may select an appropriate bitrate level based on the available bandwidth indicated by the server 320, balancing playback smoothness and video quality during streaming.

To maximize video quality while ensuring smooth playback, in some examples, each bitrate level of the different bitrate levels may correspond to a bandwidth requirement threshold, and the bitrate of the media segment may be selected by the client 310 as a highest bitrate level of which the corresponding bandwidth requirement threshold does not exceed the bandwidth value. Through this selection strategy, the client 310 may select the highest bitrate level that the available bandwidth can support, maximizing video quality presented to user (e.g. the user 140 in FIG. 1) while maintaining smooth playback of the media segment.

For illustration without suggesting any limitations, more details will be described with reference to the architecture 300 shown in FIG. 3. As shown in FIG. 3, the client 310 may include an ABR decision module 311, a media buffer 312, and a network module 313. The ABR decision module 311 may receive bandwidth estimation information, e.g., a bandwidth estimation frame (also referred to as “BWE_Frame” or “BWE frame” for purpose of discussion) and generates switch requests for adaptive bitrate decisions. The media buffer 312 may store media data received from the server 320. The network module 313 may process network data and communicate with the server 320 by sending GET requests and receiving responses including bandwidth estimation information, e.g., the BWE_Frame.

The server 320 may include a media buffer 321 and a network module 322. The media buffer 321 may store media content and provide network data to the network module 322. The network module 322 may process network data and generate the BWE_Frame that is transmitted to the client 310 in response to GET requests from the client 310.

The communication flow between the client 310 and the server 320 may involve the network module 313 of the client 310 sending GET requests to the network module 322 of the server 320. The network module 322 may respond with BWE_Frame containing the network quality metric(s). The network module 313 may forward the BWE_Frame to the ABR decision module 311. The ABR decision module 311 may use this information along with network data to make adaptive bitrate decisions and generate switch requests. The media buffer 312 may receive media data based on these decisions, enabling the client 310 to adaptively select appropriate video quality levels based on server-provided network condition assessments.

In some examples, the at least one network quality metric carried in the bandwidth estimation information may reflect at least one network condition of the transport layer connection evaluated by the server 320. The server 320 may evaluate network conditions based on various factors, such as congestion indicators, link status, and predicted bandwidth, and encapsulate the evaluation results into the bandwidth estimation frame for transmission to the client 310.

By reflecting server-evaluated network conditions, the bandwidth estimation information may enable the client 310 to leverage server-side network evaluation capabilities, which may have access to more comprehensive network information than the client side.

In some examples, after receiving the bandwidth estimation information from the server 320, the client 310 may identify a frame type identifier from the bandwidth estimation information and validate the bandwidth estimation information based on the frame type identifier. For example, the network module 313 of the client 310 may filter bandwidth estimation frames from all received frames based on the negotiated frame type identifier (such as Oxif), excluding other types of frames. The network module 313 may also perform format verification and field validity verification on the frame structure, filtering out abnormal frames.

This approach may enable the client 310 to filter and verify bandwidth estimation frames, ensuring that only valid frames are used for adaptive bitrate decision-making.

In some examples, after validating the bandwidth estimation information, the client 310 may extract network quality metrics from the bandwidth estimation information. For example, the network module 313 may sequentially read bandwidth, RTT, loss rate, jitter, and other information from the bandwidth estimation frame and store the information in a data structure for use by the ABR decision module 311.

In some examples, the ABR decision module 311 may use the network quality metrics extracted from the bandwidth estimation information to select a bitrate for a media segment. A bitrate of the media segment may be selected by comparing a bandwidth value from the at least one network quality metric against a plurality of bitrate thresholds respectively associated with different bitrate levels. In some examples, each bitrate level of the different bitrate levels corresponds to a bandwidth requirement threshold. For example, a low bitrate level (such as 360P) may correspond to a bandwidth requirement threshold of 1 Mbps, a medium bitrate level (such as 720P) may correspond to a bandwidth requirement threshold of 4 Mbps, and a high bitrate level (such as 1080P) may correspond to a bandwidth requirement threshold of 8 Mbps. The bitrate of the media segment may be selected as a highest bitrate level of which the corresponding bandwidth requirement threshold does not exceed the bandwidth value. For example, if the bandwidth value from the bandwidth estimation information is 5 Mbps, the ABR decision module 311 may select the medium bitrate level (720P) because the bandwidth requirement threshold of 4 Mbps does not exceed the bandwidth value of 5 Mbps, while the bandwidth requirement threshold of 8 Mbps for the high bitrate level (1080P) exceeds the bandwidth value.

Through the threshold comparison approach, the client 310 may compare a bandwidth value in the bandwidth estimation information from the at least one network quality metric against a plurality of bitrate thresholds associated with different bitrate levels. Each bitrate level of the different bitrate levels may correspond to a bandwidth requirement threshold. Based on the comparison, the client 310 may select a bitrate for presenting the media segment.

By selecting the highest bitrate level whose bandwidth requirement threshold does not exceed the bandwidth value, the client 310 may maximize video quality while maintaining smooth playback.

In some examples, when the client 310 receives a new bandwidth estimation frame from the server 320 and completes validation, the client 310 may update the network quality metrics in real time, and the ABR decision module 311 may dynamically adjust the bitrate selection, achieving a balance between smooth playback and video clarity.

Through the negotiation of the capability of the bandwidth estimation information during the handshake phase, the client 310 and the server 320 may establish support for bandwidth estimation at the time of connection establishment without additional negotiation overhead, reducing latency and enabling immediate bandwidth estimation upon connection establishment.

Through the separate flow controls for the bandwidth estimation frame and media data frames, the bandwidth estimation information may be transmitted independently of media content, avoiding interference from business traffic on bandwidth estimation results and producing more accurate network quality measurements.

Through the TLV structure of the network information fields, the bandwidth estimation frame may flexibly encode various types of network quality metrics and support addition of further metric types in the future without breaking compatibility, providing good extensibility for evolving network measurement requirements.

Through the above approach, the server 320 may evaluate network conditions and proactively provide bandwidth estimation information to the client 310, enabling the client 310 to leverage server-side network evaluation results for adaptive bitrate decision-making, rather than relying on client-side post-hoc measurement of completed downloads. This approach may improve the timeliness of perceiving network fluctuations, reduce delays or deviations in bandwidth estimation, and thereby improve the timeliness and accuracy of adaptive bitrate decisions. Additionally, because the bandwidth estimation frame is transmitted independently of media data frames with separate flow controls, the measurement results may be more accurate and less affected by business traffic. Furthermore, because the TLV structure is extensible, the bandwidth estimation frame may support addition of further metric types in the future, providing good compatibility and extensibility.

In some examples, alternative approaches may also be used to implement server-assisted bandwidth estimation. For example, network metrics may be encapsulated in a QUIC datagram for transmission, achieving lightweight delivery. However, the QUIC datagram does not guarantee reliable transmission and is prone to packet loss and out-of-order delivery, resulting in weaker metric integrity and stability compared to the bandwidth estimation frame approach, and making it difficult to achieve fine-grained isolation from business traffic, resulting in lower evaluation accuracy. As another example, network metrics may be obtained through HTTP interface polling, which is simple to implement and has strong compatibility. However, this approach has large request header overhead, high latency, cannot negotiate during the QUIC handshake phase, and is prone to business queue blocking, resulting in much lower real-time performance compared to the bandwidth estimation frame approach, and cannot achieve transmission isolation, resulting in larger bandwidth estimation deviation.

In some examples, each type of network quality metric may be identified by a specific type code within the network information field. For example, a bandwidth metric may be identified by a type code of 0x01 and encoded as a 32-bit unsigned integer in units of kilobits per second. A round-trip time metric may be identified by a type code of 0x02 and encoded as a 32-bit unsigned integer in units of milliseconds. A loss rate metric may be identified by a type code of 0x03 and encoded as an 8-bit unsigned integer in units of percentage. A jitter metric may be identified by a type code of 0x04 and encoded as a 32-bit unsigned integer in units of milliseconds. It should be understood that the specific type codes and data types described above are merely examples, and other type codes and data types may also be used.

Compared with the conventional architecture 200 of FIG. 2, the architecture 300 of FIG. 3 introduces a server-assisted bandwidth estimation mechanism. In the architecture 200, the client 210 may rely on download speed measurements from the network module 213 to estimate bandwidth, which may be a post-hoc measurement of completed downloads. In contrast, in the architecture 300, the server 320 may proactively provide bandwidth estimation information to the client 310 through the BWE_Frame, enabling the client 310 to leverage server-side network evaluation results for adaptive bitrate decision-making. This approach may improve the timeliness of perceiving network fluctuations (such as instantaneous congestion or rapid bandwidth changes), reduce delays or deviations in bandwidth estimation, and thereby improve the timeliness and accuracy of adaptive bitrate decisions.

In contrast to the conventional architecture depicted in FIG. 2, the architecture 300 shown in FIG. 3 presents multiple differences. First, regarding the measurement entity and timing, the conventional approach may involve the client performing post-hoc measurement through video download speed, which may be a passive and lagging measurement. In contrast, in the architecture 300, the server 320 may provide network metrics before video playback, before bitrate switching, and before network fluctuations, achieving proactive and in-progress bandwidth perception.

Second, regarding transmission channel independence, the conventional approach may share the same connection or channel for measurement and business data transmission, which may be susceptible to interference from playback cache, request queuing, and segment size. In contrast, in the architecture 300, the bandwidth estimation information may be transmitted through a dedicated protocol with independent transmission, reducing contamination of bandwidth estimation by business traffic and producing more accurate measurement results.

Third, regarding bandwidth estimation methodology, the conventional approach may only perform smoothed estimation based on completed downloads, which may react slowly to sudden congestion or network transitions. In contrast, in the architecture 300, the server 320 may provide link status, congestion indicators, predicted bandwidth, and other information, enabling the client 310 to obtain more forward-looking bandwidth input for more timely and stable ABR decisions.

Fourth, regarding protocol extensibility and standardization, the conventional approach may rely on pure client-side logic with poor extensibility. In contrast, the architecture 300 may define dedicated measurement frame formats, interaction flows, and feedback fields at the transport layer (such as based on QUIC), forming a reusable, identifiable, and protectable server-side measurement protocol rather than scattered client-side logic.

FIG. 4 illustrates a schematic diagram of a BWE Frame structure 400 in accordance with some examples. For the purpose of illustration without suggesting any limitation, the BWE Frame structure 400 may be an example of the bandwidth estimation frame discussed in FIG. 3. As shown in FIG. 4, the BWE Frame structure 400 may include a type field 410 and a value field 420. The type field 410 contains a frame type identifier.

The Value field 420 may contain a Count field (shown as “Count (i)” in FIG. 4) and at least one network information field, labeled as NI_1(TLV), NI_2(TLV), through NI_N(TLV). The Count field may indicate a number of network information fields comprised in the value field 420. The at least one network information field may indicate that the value field 420 may accommodate a variable number of network information structures.

As further shown in FIG. 4, each network information field may have a Type-Length-Value (TLV) structure. The TLV structure may include a type field (Type (i)) 431, a length field (Length (i)) 432, and a value field (Value) 433. Alternatively or in addition, the TLV structure may further be extensible for addition of a further metric type. The type field 431 may identify a category of network information being conveyed. The length field 432 may specify a size of the value field. The value field 433 may contain actual network information data. The TLV structure may be extensible for addition of further metric types, allowing for flexible encoding of various network metrics within the BWE Frame structure 400. This approach may provide a structured format for the bandwidth estimation information, enabling efficient parsing and extraction of network quality metrics.

In some examples, the BWE Frame structure 400 may have the following hierarchical field structure. At the first level, the TYPE field 410 may indicate the frame type, which may be fixed to a negotiated value (such as 0x1f) with a data length of 1 byte. The VALUE field may contain the payload of the BWE Frame, and its length may be determined by the subsequent fields. At the second level within the value field 420, the Count field may describe the number of subsequent network information structures and may use variable-length encoding. Each network information structure (such as NI_1 through NI_n) may be at the second level. At the third level within each network information structure, the type field 431 may indicate the type of network information and may use variable-length encoding, the length field 432 may indicate the length of the value field 433 and may use variable-length encoding, and the value field 433 contains the specific value of the network information with the number of bytes indicated by the length field 432.

In some examples, the BWE Frame structure 400 may be represented in the following pseudo-code format:

```
BWE Frame { //Bandwidth Estimator Frame
  Type (i) = 0x1f,
  Value (..),
}
Value field of BWE Frame {
  Count (i),
  NetworkInfo (..) ...,
}
NetworkInfo structure {
  Type (i),
  Length (i),
  Value (..),
}
```

In this pseudo-code format, (i) denotes a variable-length integer encoding, and (..) denotes a variable-length field. The Type field of the BWE Frame identifies the frame type (for example, 0x1f). The Count field indicates the number of subsequent NetworkInfo structures. Each NetworkInfo structure follows a TLV format, where the Type field identifies the category of network information, the Length field specifies the size of the Value field, and the Value field contains the actual network metric data.

In some examples, the BWE Frame structure 400 may be represented in the following format: BWE Frame {Type (i), Value (..),} where the Value field of the BWE Frame includes {Count (i), NetworkInfo (..) . . . ,} and each NetworkInfo structure includes {Type (i), Length (i), Value (..),}. In this representation, (i) denotes a variable-length integer encoding, and (..) denotes a variable-length field. The Type field of the BWE Frame identifies the frame type. The Count field indicates the number of subsequent NetworkInfo structures. Each NetworkInfo structure follows a TLV format, where the Type field identifies the category of network information, the Length field specifies the size of the Value field, and the Value field contains the actual network metric data.

Table 3 shows an example of the hierarchical field structure of the BWE Frame.

TABLE 3

| First | Second | Third | | |
|---|---|---|---|---|
| Level | Level | Level | | |
| Field | Field | Field | Field Description | Data Length |
| Type | | | Frame type (fixed to a | 1 byte |
| | | | negotiated value, e.g., 0x1f) | |
| Value | | | Payload of BWE_Frame | Determined by a |
| | | | | subsequent field |
| | Count | | The number of subsequent | Variable-length |
| | | | NetworkInfo structures | encoding |
| | NI_1 | Type | Type of network | Variable-length |
| | | | information | encoding |
| | | Length | Length of Value field | Variable-length |
| | | | | encoding |
| | | Value | Specific value of network | Length bytes |
| | | | information | |
| | . . . | . . . | . . . | . . . |
| | NI_n | Type | Type of network | Variable-length |
| | | | information | encoding |
| | | Length | Length of Value field | Variable-length |
| | | | | encoding |
| | | Value | Specific value of network | Length bytes |
| | | | information | |

Table 4 shows an example of types of the network information (NetworkInfo) and their corresponding units and data formats.

TABLE 4

| Type | Metric Name | Unit and Data Format |
|---|---|---|
| 0x01 | bandwidth | kbps-uint32_t |
| 0x02 | rtt | ms-uint32_t |
| 0x03 | loss rate | %-uint8_t |
| 0x04 | jitter | ms-uint32_t |

It should be understood that the specific type codes and data types described above are merely examples, and other type codes and data types may also be used. In some examples, each negotiation parameter field may have a data length of 1 byte.

In some examples, the Count field, the type field 431 of each network information field, and the length field 432 of each network information field may use variable-length encoding. For example, the frame type identifier may be predefined as a specific value such as 0x1f.

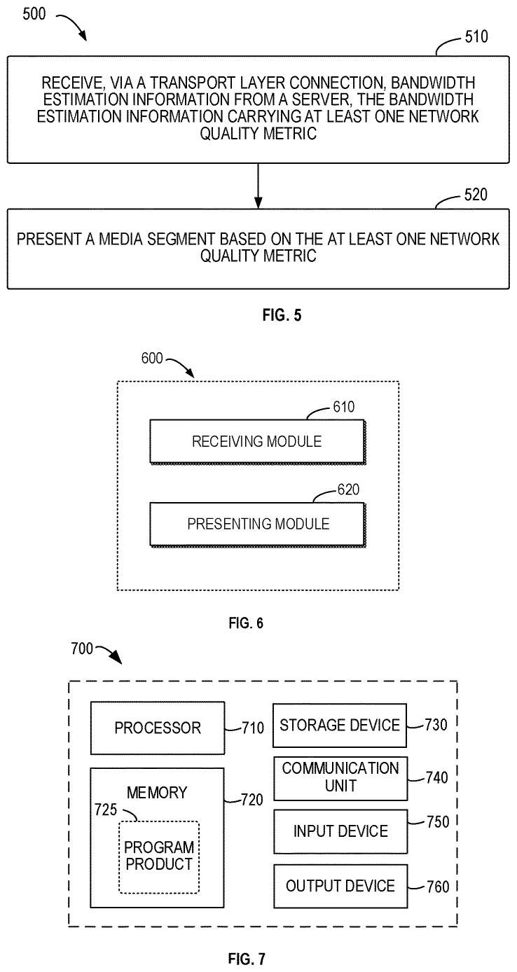

FIG. 5 illustrates a flowchart of an example process 500 for adaptive bitrate streaming in accordance with some examples. The process 500 may be implemented at the client 110. The process 500 is described below with reference to FIG. 1.

As shown in FIG. 5, at block 510, the client 110 receives, via a transport layer connection, bandwidth estimation information from a server, the bandwidth estimation information carrying at least one network quality metric, a capability of the bandwidth estimation information having been negotiated during a handshake phase of the transport layer connection.

At block 520, the client 110 presents a media segment based on the at least one network quality metric.

Through the above process, the server may evaluate network conditions and proactively provide bandwidth estimation information to the client 110, enabling the client 110 to leverage server-side network evaluation results for adaptive bitrate decision-making, rather than relying on client-side post-hoc measurement of completed downloads. Since the capability of the bandwidth estimation information is negotiated during the handshake phase of the transport layer connection, the client 110 and the server may confirm support for the bandwidth estimation information at the time of connection establishment, thereby enabling reliable transmission of the bandwidth estimation information. As such, the timeliness of perceiving network fluctuations (such as instantaneous congestion or rapid bandwidth changes) may be improved, delays or deviations in bandwidth estimation may be reduced, and thereby the timeliness and accuracy of adaptive bitrate decisions may be improved.

In some examples, the bandwidth estimation information may comprise a bandwidth estimation frame, and the bandwidth estimation frame and one or more media data frames carrying the media segment may be transmitted via the transport layer connection with separate flow controls. This may reduce interference of business traffic on bandwidth estimation results, making the measurement results more accurate.

In some examples, the capability of the bandwidth estimation information may be negotiated by: transmitting, to the server, indication information of the capability of the bandwidth estimation information; and receiving, from the server, confirmation information about the capability of the bandwidth estimation information. This may enable the client 110 and the server to confirm support for the bandwidth estimation information through a bidirectional negotiation process, ensuring that both parties agree on the parameters of the bandwidth estimation information before transmission begins.

In some examples, the indication information of the capability of the bandwidth estimation information may comprise at least one of: an indication of bandwidth estimation support, a frame type identifier, or a transmission interval that is requested. This may enable the client 110 to specify its preferences and capabilities for receiving bandwidth estimation information, allowing the server to tailor the bandwidth estimation information accordingly.

In some examples, the confirmation information about the capability of the bandwidth estimation information may comprise at least one of: an indication of acceptance, an identifier of a frame type, or a transmission interval that is confirmed. This may enable the server to confirm the parameters of the bandwidth estimation information, ensuring that the client 110 knows what to expect when receiving bandwidth estimation frames.

In some examples, the bandwidth estimation information may be received from the server according to the transmission interval that is confirmed. This may enable the client 110 to receive bandwidth estimation information at predictable intervals, facilitating timely updates of network quality metrics for adaptive bitrate decision-making.

In some examples, the transport layer connection may be a Quick UDP Internet Connections (QUIC) connection. The low-latency and multiplexing capabilities of QUIC may be leveraged for efficient transmission of bandwidth estimation information.

In some examples, the capability of the bandwidth estimation information may be negotiated via an extension field of an initial packet of the QUIC connection. This may enable the negotiation to be completed during the connection establishment phase without additional round trips, reducing latency.

In some examples, the bandwidth estimation information may be a bandwidth estimation frame having a predefined frame type identifier. This may enable the bandwidth estimation information to be transmitted as a bandwidth estimation frame.

In some examples, the process 500 may further comprise: identifying, from a plurality of received frames, the bandwidth estimation information based on a predefined frame type identifier; and validating at least one field of the bandwidth estimation information. This may enable the client 110 to filter and verify bandwidth estimation frames, ensuring that only valid frames are used for adaptive bitrate decision-making.

In some examples, the bandwidth estimation information may comprise a frame type field and a frame value field, the frame value field comprising a count field and at least one network information field. In this way, a structured format may be provided for the bandwidth estimation information, enabling efficient parsing and extraction of network quality metrics.

In some examples, the count field may indicate a number of network information fields comprised in the frame value field. This may enable the client 110 to determine how many network quality metrics are included in the bandwidth estimation information, facilitating accurate parsing of the frame.

In some examples, each network information field may have a Type-Length-Value (TLV) structure, the TLV structure comprising a type field, a length field, and a value field, and/or being extensible for addition of a further metric type. This may provide a flexible and extensible format for encoding network quality metrics, allowing for addition of new metric types in the future without breaking compatibility.

In some examples, the at least one network quality metric may comprise at least one of: a bandwidth value, a round-trip time value, a loss rate value, or a jitter value. This may enable the client 110 to receive comprehensive network condition information for making informed adaptive bitrate decisions.

In some examples, the at least one network quality metric carried in the bandwidth estimation information may be associated with at least one network condition of the transport layer connection evaluated by the server. This may enable the client 110 to leverage server-side network evaluation capabilities, which may have access to more comprehensive network information than the client side.

In some examples, the process 500 may further comprise: comparing a bandwidth value in the bandwidth estimation information from the at least one network quality metric against a plurality of bitrate thresholds associated with different bitrate levels; and selecting a bitrate for presenting the media segment based on the comparison. This may enable the client 110 to select an appropriate bitrate level based on the available bandwidth, balancing playback smoothness and video quality.

In some examples, each bitrate level of the different bitrate levels may correspond to a bandwidth requirement threshold, and the bitrate may be selected as a highest bitrate level of which the corresponding bandwidth requirement threshold does not exceed the bandwidth value. This may enable the client 110 to select the highest quality level that the network can support, maximizing video quality while maintaining smooth playback.

A corresponding apparatus for implementing the above method or process is also provided. FIG. 6 illustrates a block diagram of an apparatus 600 for adaptive bitrate streaming in accordance with some examples. The apparatus 600 may be implemented in or included in an electronic device. The electronic device may be a client, e.g., the client 110 or the client 310, or a server, e.g., the server 130 or the server 320. The modules/components in the apparatus 600 may be implemented by hardware, software, firmware, or any combination thereof.

As shown in FIG. 6, the apparatus 600 includes a receiving module 610 and a presenting module 620. The receiving module 610 is configured to receive, via a transport layer connection, bandwidth estimation information from a server, the bandwidth estimation information carrying at least one network quality metric, a capability of the bandwidth estimation information having been negotiated during a handshake phase of the transport layer connection. The presenting module 620 is configured to present a media segment based on the at least one network quality metric.

In some examples, the bandwidth estimation information may comprise a bandwidth estimation frame, and the bandwidth estimation frame and one or more media data frames carrying the media segment may be transmitted via the transport layer connection with separate flow controls. In some examples, the receiving module 610 may be further configured to: transmit, to the server, indication information of the capability of the bandwidth estimation information; and receive, from the server, confirmation information about the capability of the bandwidth estimation information. In some examples, the indication information of the capability of the bandwidth estimation information may comprise at least one of: an indication of bandwidth estimation support, a frame type identifier, or a transmission interval that is requested.

In some examples, the confirmation information about the capability of the bandwidth estimation information may comprise at least one of: an indication of acceptance, an identifier of a frame type, or a transmission interval that is confirmed. In some examples, the receiving module 610 may be further configured to receive the bandwidth estimation information from the server according to a transmission interval that is confirmed. In some examples, the transport layer connection may be a Quick UDP Internet Connections (QUIC) connection. In some examples, the capability of the bandwidth estimation information may be negotiated via an extension field of an initial packet of the QUIC connection. In some examples, the bandwidth estimation information may be a bandwidth estimation frame having a predefined frame type identifier.

In some examples, the apparatus 600 may further include a validation module, configured to: identify, from a plurality of received frames, the bandwidth estimation information based on a predefined frame type identifier; and validate at least one field of the bandwidth estimation information. In some examples, the bandwidth estimation information may comprise a frame type field and a frame value field, the frame value field comprising a count field and at least one network information field. In some examples, the count field may indicate a number of network information fields comprised in the frame value field. In some examples, each network information field may have a Type-Length-Value (TLV) structure, the TLV structure comprising a type field, a length field, and a value field, and/or being extensible for addition of a further metric type.

In some examples, the at least one network quality metric may comprise at least one of: a bandwidth value, a round-trip time value, a loss rate value, or a jitter value. In some examples, the at least one network quality metric carried in the bandwidth estimation information may be associated with at least one network condition of the transport layer connection evaluated by the server. In some examples, the presenting module 620 may include a selecting module, configured to: compare a bandwidth value in the bandwidth estimation information from the at least one network quality metric against a plurality of bitrate thresholds associated with different bitrate levels; and select a bitrate for presenting the media segment based on the comparison. In some examples, each bitrate level of the different bitrate levels may correspond to a bandwidth requirement threshold, and the bitrate of the media segment may be selected as a highest bitrate level of which the corresponding bandwidth requirement threshold does not exceed the bandwidth value.

The modules included in the apparatus 600 may be implemented in various ways, including software, hardware, firmware, or any combination thereof. In some examples, one or more modules may be implemented using software and/or firmware, such as machine-executable instructions stored on a storage medium. In addition to or as an alternative to machine-executable instructions, some or all of the units in the apparatus 600 may be implemented at least in part by one or more hardware logic components. As an example and not limitation, exemplary types of hardware logic components that may be used include Field Programmable Gate Arrays (FPGAs), Application Specific Integrated Circuits (ASICs), Application Specific Standard Parts (ASSPs), Systems on a Chip (SOCs), Complex Programmable Logic Devices (CPLDs), and the like.

FIG. 7 illustrates a block diagram of a computing device 700 in which one or more examples may be implemented. It should be understood that the computing device 700 shown in FIG. 7 is merely exemplary and should not constitute any limitation on the functionality and scope of the examples described herein. The computing device 700 shown in FIG. 7 may be used to implement the client 110 and/or the apparatus 600 as discussed above.

As shown in FIG. 7, the computing device 700 is in the form of a general-purpose electronic device. Components of the computing device 700 may include, but are not limited to, one or more processing units or processors 710, a memory 720, a storage device 730, one or more communication units 740, one or more input devices 750, and one or more output devices 760.

The processor 710 may be an actual or virtual processor and is capable of performing various processing according to programs stored in the memory 720. In a multi-processor system, multiple processors execute computer-executable instructions in parallel to improve the parallel processing capability of the computing device 700.

The computing device 700 typically includes multiple computer storage media. Such media may be any available media that is accessible by the computing device 700, including but not limited to volatile and non-volatile media, removable and non-removable media. The memory 720 may be volatile memory (e.g., registers, cache, Random Access Memory (RAM)), non-volatile memory (e.g., Read-Only Memory (ROM), Electrically-Erasable Programmable Read-Only Memory (EEPROM), flash memory), or some combination thereof. The storage device 730 may be removable or non-removable media and may include machine-readable media such as flash drives, magnetic disks, or any other media that can be used to store information and/or data and can be accessed within the computing device 700.

The computing device 700 may further include additional removable/non-removable, volatile/non-volatile storage media. Although not shown in FIG. 7, a magnetic disk drive for reading from or writing to a removable, non-volatile magnetic disk (e.g., a “floppy disk”) and an optical disk drive for reading from or writing to a removable, non-volatile optical disk may be provided. In these cases, each drive may be connected to a bus (not shown) by one or more data media interfaces. The memory 720 may include a program product 725 having one or more program modules configured to perform various methods or actions of various examples.

The communication unit 740 enables communication with other electronic devices through communication media. Additionally, the functionality of the components of the computing device 700 may be implemented in a single computing cluster or multiple computing machines that are capable of communicating through communication connections. Accordingly, the computing device 700 may operate in a networked environment using logical connections to one or more other servers, network personal computers, or another network node.

The input device 750 may be one or more input devices such as a mouse, keyboard, trackball, or the like. The output device 760 may be one or more output devices such as a display, speakers, printer, or the like. The computing device 700 may also communicate as desired through the communication unit 740 with one or more external devices (not shown), such as storage devices, display devices, or the like, with one or more devices that enable a user to interact with the computing device 700, or with any device (e.g., a network card, a modem, etc.) that enables the computing device 700 to communicate with one or more other electronic devices. Such communication may be performed via Input/Output (I/O) interfaces (not shown).

According to an illustrative implementation, there is provided a computer-readable storage medium having computer-executable instructions stored thereon, the computer-executable instructions being executed by a processor to implement the method described above. According to an illustrative implementation herein, there is also provided a computer program product tangibly stored on a non-transitory computer-readable medium and including computer-executable instructions, the computer-executable instructions being executed by a processor to implement the method described above.

Various aspects herein are described herein with reference to flowcharts and/or block diagrams of methods, apparatuses, devices, and computer program products implemented according to the examples. It would be appreciated that each block of the flowchart and/or block diagram, and combinations of blocks in the flowchart and/or block diagram, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing the functions/actions specified in one or more blocks of the flowchart and/or block diagram. These computer-readable program instructions may also be stored in a computer-readable storage medium, these instructions cause a computer, a programmable data processing apparatus, and/or other devices to work in a specific manner, so that the computer-readable medium storing the instructions includes a manufactured product, which includes instructions for implementing various aspects of the functions/actions specified in one or more blocks of the flowchart and/or block diagram.

The computer-readable program instructions may be loaded onto a computer, other programmable data processing apparatus, or other devices, so that a series of operation steps are performed on the computer, other programmable data processing apparatus, or other devices to produce a computer-implemented procedure, so that the instructions executed on the computer, other programmable data processing apparatus, or other devices implement the functions/actions specified in one or more blocks of the flowchart and/or block diagram.

The flowchart and block diagram in the drawings show the possibly implemented architectures, functions, and operations of the system, method, and computer program product according to multiple implementations herein. In this regard, each block in the flowchart or block diagram may represent a module, program segment, or part of instructions, and the module, program segment, or part of instructions contains one or more executable instructions for implementing the specified logical functions. In some alternative implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagram and/or flowchart, and the combination of blocks in the block diagram and/or flowchart, may be implemented by a dedicated hardware-based system that executes specified functions or actions, or may be implemented by a combination of dedicated hardware and computer instructions.

The implementations herein have been described above, and the above description is illustrative, non-exhaustive, and not limited to the disclosed implementations. Without departing from the scope and spirit of the illustrated implementations, many modifications and changes will be apparent to those of ordinary skill in the art. The choice of terms used herein is intended to best explain the principles of the implementations, the practical applications, or improvements to the technologies in the market, or to enable other ordinary skilled persons in the art to understand the implementations disclosed herein.

1. A method for adaptive bitrate streaming, comprising:
receiving, via a transport layer connection, bandwidth estimation information from a server, the bandwidth estimation information carrying at least one network quality metric, a capability of the bandwidth estimation information having been negotiated during a handshake phase of the transport layer connection; and
presenting a media segment based on the at least one network quality metric.

2. The method of claim 1, wherein the bandwidth estimation information comprises a bandwidth estimation frame, and the bandwidth estimation frame and one or more media data frames carrying the media segment are transmitted via the transport layer connection with separate flow controls.

3. The method of claim 1, wherein the capability of the bandwidth estimation information is negotiated by:
transmitting, to the server, indication information of the capability of the bandwidth estimation information; and
receiving, from the server, confirmation information about the capability of the bandwidth estimation information.

4. The method of claim 3, wherein the indication information of the capability of the bandwidth estimation information comprises at least one of: an indication of bandwidth estimation support, a frame type identifier, or a transmission interval that is requested.

5. The method of claim 3, wherein the confirmation information about the capability of the bandwidth estimation information comprises at least one of: an indication of acceptance, an identifier of a frame type, or a transmission interval that is confirmed.

6. The method of claim 5, wherein the bandwidth estimation information is received from the server according to the transmission interval that is confirmed.

7. The method of claim 1, wherein the transport layer connection is a Quick UDP Internet Connections (QUIC) connection.

8. The method of claim 7, wherein the capability of the bandwidth estimation information is negotiated via an extension field of an initial packet of the QUIC connection.

9. The method of claim 7, wherein the bandwidth estimation information is a bandwidth estimation frame having a predefined frame type identifier.

10. The method of claim 1, further comprising:
identifying, from a plurality of received frames, the bandwidth estimation information based on a predefined frame type identifier; and
validating at least one field of the bandwidth estimation information.

11. The method of claim 1, wherein the bandwidth estimation information comprises a frame type field and a frame value field, the frame value field comprising a count field and at least one network information field.

12. The method of claim 11, wherein the count field indicates a number of network information fields comprised in the frame value field.

13. The method of claim 11, wherein each network information field has a Type-Length-Value (TLV) structure, the TLV structure comprising a type field, a length field, and a value field, and/or being extensible for addition of a further metric type.

14. The method of claim 1, wherein the at least one network quality metric comprises at least one of: a bandwidth value, a round-trip time value, a loss rate value, or a jitter value.

15. The method of claim 1, wherein the at least one network quality metric carried in the bandwidth estimation information is associated with at least one network condition of the transport layer connection evaluated by the server.

16. The method of claim 1, wherein presenting the media segment comprises:
comparing a bandwidth value in the bandwidth estimation information from the at least one network quality metric against a plurality of bitrate thresholds associated with different bitrate levels; and
selecting a bitrate for presenting the media segment based on the comparison.

17. The method of claim 16, wherein each bitrate level of the different bitrate levels corresponds to a bandwidth requirement threshold, and wherein the bitrate is selected as a highest bitrate level of which the corresponding bandwidth requirement threshold does not exceed the bandwidth value.

18. An electronic device, comprising:
at least one processor; and
at least one memory coupled to the at least one processor and having instructions executable by the at least one processor stored thereon, the instructions, when executed by the at least one processor, causing the electronic device to perform operations comprising:
receive, via a transport layer connection, bandwidth estimation information from a server, the bandwidth estimation information carrying at least one network quality metric, a capability of the bandwidth estimation information having been negotiated during a handshake phase of the transport layer connection; and
present a media segment based on the at least one network quality metric.

19. The electronic device of claim 18, wherein the bandwidth estimation information comprises a bandwidth estimation frame, and the bandwidth estimation frame and one or more media data frames carrying the media segment are transmitted via the transport layer connection with separate flow controls.

20. A non-transitory computer-readable storage medium storing instructions that, when executed by one or more processors, cause the one or more processors to perform operations comprising:
receiving, via a transport layer connection, bandwidth estimation information from a server, the bandwidth estimation information carrying at least one network quality metric, a capability of the bandwidth estimation information having been negotiated during a handshake phase of the transport layer connection; and
presenting a media segment based on the at least one network quality metric.
